(19) United States
(12) Patent Application Publication
(10) Pub. No.: US 2010/0106799 A1
(43) Pub. Date: Apr. 29, 2010

(54) METHOD AND SYSTEM FOR DISTRIBUTING MUSICAL CONTENT

(75) Inventor: Daniele CALABRESE, Washington, DC (US)

Correspondence Address: ARENT FOX LLP, 1050 CONNECTICUT AVENUE, N.W., SUITE 400, WASHINGTON, DC, 20036, US

(73) Assignee: Daniele Calbrese, Washington, DC (US)

(21) Appl. No.: 12/581,661

(22) Filed: Oct. 19, 2009

Related U.S. Application Data
(60) Provisional application No. 61/106,339, filed on Oct. 17, 2008.

(51) Int. Cl. G06F 15/16; G06F 3/01

(52) U.S. Cl. 709/217; 715/745

(57) ABSTRACT

Methods and systems for distributing musical content are provided. A user profile is received, and a client application is downloaded to the user's mobile device. Based on the user's profile, an identifier of another user, or an identifier of a place, musical content is distributed to the user's mobile device. Based on the type of musical content, the user's profile may be updated. Further, based on the type of musical content, additional information may be provided to the user's mobile device.

### BACKGROUND OF THE INVENTION

1. Field of the Invention

Aspects of the present invention are directed to platform-independent client-server methods and systems for distributing (e.g., streaming and/or broadcasting) musical content. More specifically, aspects of the present invention are directed to methods and systems for distributing musical content to mobile telephones and other handheld devices.

2. Background of the Related Art

The use of mobile phones and other handheld devices (such as Personal Digital Assistants (PDAs), Blackberry devices, and the like) has become prevalent in daily life. Factors such as the increase in mobile telephone computing capacity, the declining cost of smart multimedia devices worldwide, the lowered costs for on-line streaming, the proliferation of local musical content and digital distribution channels, all contribute to the emerging need in the art for improved and optimized methods and systems for distributing musical content to mobile telephones or other handheld devices. There are known in the art methods and systems for distributing musical content to handheld devices. However, the current methods and systems suffer from a number of shortcomings.

For example, users are facing a number of obstacles to making their own music libraries portable. These obstacles include limitations on the amount of musical content that can be transferred from a computer to a mobile telephone. Further, if a user desires to stream musical content from the user's computer to a mobile device, the user must connect the computer to the mobile telephone via loading an application on both the computer and the mobile telephone, have an active wireless network connections between the local and the mobile phone and ensure that the connection is not lost or interrupted in any way. In addition, some level of technical knowledge is required to be able to stream musical content to and from a mobile device.

As another example, recommendation engines are database systems with analytical approaches to detecting which, e.g., digital file is similar to a file or files previously preferred by specific customers or users. These preferences can be explicit (through rating systems), implicit (through behavioral analysis), or a combination of both. The success of these recommendations has generally been measured by the similarity of these files in some objective, intrinsic measure. For example, the success has been measured by determining whether the recommended file has a parameter, with weightings, that is within some prescribed distance of one or more files known to have been preferred by the customer. Parameters associated with a digital file can be generated by collaborative filtering, digital signal processing analysis, and other techniques. However, there is currently no viable technique for associating digital files with a specific person or place.

Additional shortcomings of the current methods and systems for distributing musical content to handheld devices include the fact that a user cannot immediately listen to musical content that is in the user's musical library or personal web radio. Also, many radio streams are not currently available for streaming to a mobile device, i.e., the number of applications available for mobile devices is still limited. Furthermore, if a user desires to access the user's preferred music choices and the user's network of music friends, the user must separately log in to a number of platforms, such as myspace, facebook, last.fm, Pandora, imeem, and the user's mobile telephone. In addition, users risk losing their entire music libraries, should their computers or mobile telephones fail.

There is a need in the art, therefore, for methods and systems for musical content distribution and/or streaming that provide portability of a user's entire music library. Further, there is a need in the art for methods and systems for distribution musical content that provide multiple users (e.g., members of one family) with access to the entire content of the music library stored on a computer. Further, there is a need in the art for methods and systems for musical content distribution that do not limit the amount of musical content that can be transferred to a mobile telephone. Further, there is a need in the art for methods and systems for musical content distribution that do not require a physical connection between, e.g., a computer, and a mobile telephone. In addition, there is a need in the art for methods and systems for musical content distribution that do not require technical expertise to be able to stream musical content to and from a mobile device.

There is yet a further need in the art for methods and systems for musical content distribution that enable a user to immediately listen to musical content that is not necessarily in the user's musical library or personal web radio. There is a further need in the art for methods and systems for musical content distribution that make available any digital radio streams for streaming to a mobile device. There is yet a further need in the art for methods and systems for musical content distribution that are platform-independent, both on the desktop as well on the mobile side and limit the risk users face of losing their entire music libraries, should their computers or mobile telephones fail. There is a further need in the art for methods and systems that would allow association of digital files with people, places, or both.

There is yet a further need in the art for methods and systems for musical content distribution that use the mobile device's Global Positioning System (GPS) or other location function (for instance, cellular tower triangulation, or public Wi-Fi network maps) to provide a user with the ability to stream music from available radio stations in the vicinity, or to connect with a friend who is located nearby and is listening to music that corresponds to the user's musical tastes.

### SUMMARY OF THE INVENTION

Aspects of the present invention solve the above-identified needs, and others, by providing methods and systems for musical content distribution that provide portability of a user's entire music library. Further, aspects of the present invention relate to methods and systems for distributing musical content that provide multiple users (e.g., members of one family) with access to the entire content of the music library stored on a computer. Moreover, aspects of the present invention provide methods and systems for musical content distribution that do not limit the amount of musical content that can be transferred to a mobile telephone. Furthermore, aspects of the present invention are directed to methods and systems for musical content distribution that do not require a physical connection between, e.g., a computer, and a mobile telephone. In addition, aspects of the present invention relate to methods and systems for musical content distribution that do not require technical expertise to be able to stream musical content to and from a mobile device. In addition, aspects of the present invention relate to methods and systems for musical content distribution to be shared with Friends in a social network.

Additional aspects of the present invention are directed to methods and systems for musical content distribution that enable a user to immediately listen to musical content that is not necessarily in the user's musical library or personal web radio. Further aspects of the present invention relate to methods and systems that make available any digital radio streams for distribution to a mobile device. Further aspects of the present invention provide methods and systems for that limit the risk users face of losing their entire music libraries, should their computers or mobile telephones fail. Yet further aspects of the present invention are directed to methods and systems for musical content distribution that use the mobile device's Global Positioning System (GPS) or other location function (for instance, cellular tower triangulation, or public Wi-Fi network maps) to provide a user with the ability to stream music from available radio stations in the vicinity, or to connect with a friend who is located nearby and is listening to music that corresponds to the user's musical tastes. In addition, aspects of the present invention relate to methods and systems for musical content distribution to be shared with Friends in a social network. Further, aspects of the present invention allow association of digital files with people, places, or both. Additional advantages and novel features of the invention will be set forth in part in the description that follows, and in part will become more apparent to those skilled in the art upon examination of the following or upon learning by using the invention.

### BRIEF DESCRIPTION OF THE FIGURES

For a more complete understanding of the present invention, the needs satisfied thereby, and the objects, features, and advantages thereof, reference now is made to the following description taken in connection with the accompanying drawings.

FIG. 1 shows an exemplary flowchart of the method for distributing musical content to a mobile device, in accordance with an aspect of the present invention;

FIG. 2 shows an open architecture technology platform, in accordance with aspects of the present invention;

FIG. 3 presents an exemplary system diagram of various hardware components and other features, for use in accordance with an aspect of the present invention;

FIG. 4 is a block diagram of various exemplary system components, for use in accordance with an embodiment of the present invention.

### DETAILED DESCRIPTION OF THE INVENTION

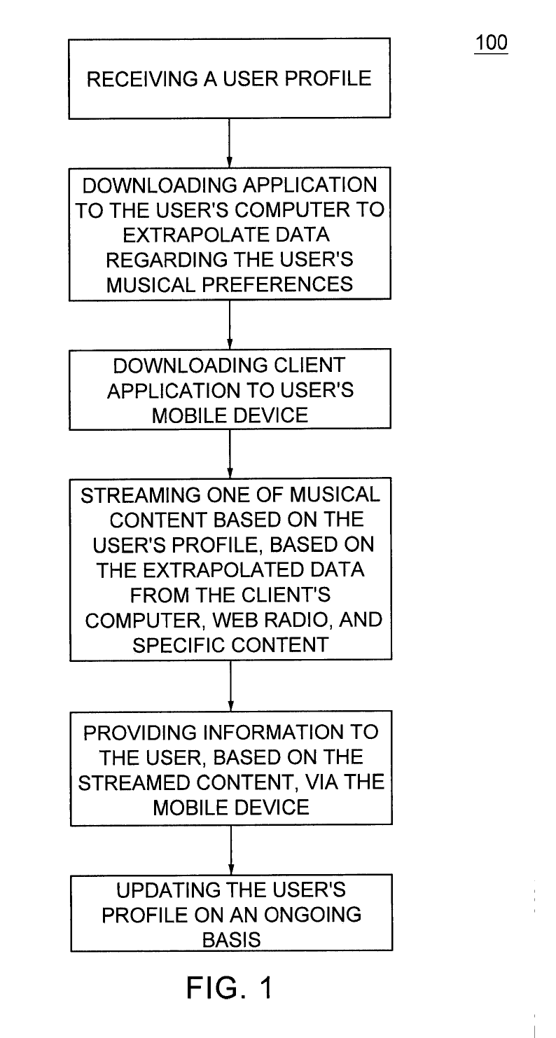

Referring now to FIG. 1, therein shown is exemplary flowchart of the method for distributing musical content to a mobile device, in accordance with an aspect of the present invention. In accordance with one aspect, a user may access a web site or a specific mobile application (e.g., via a computer or mobile device) to create a user profile. The profile may include the user's musical preferences (e.g., one or more of specific genres and artists), the user's mobile device preferences, the user's participation in social networks, if any (so that the user may share music that one of the user's social network friends is listening to, if in proximity to the user), the user's preferred web radios, and/or information about the computer that stores the user's musical content, if any. In accordance with aspects of the present invention, the user's profile may be automatically updated, on an ongoing basis, based on factors such as the type of music the user listens to and when the user listens to music, among other factors, as the user's preferences evolve over time. In addition, the user may update the stored profile at any time by accessing the web site. A part of the user information stored on the central server may be stored, for example, on the user's mobile device, to ensure an enhanced user experience.

If the user has a library of music on the user's home computer, in accordance with aspects of the present invention, an application may be downloaded that analyzes the musical content on the computer and extrapolates data about the stored songs, artists, user-preferred music genres, when the user listens to music and what kinds of music the user listens to, among other data. In accordance with aspects of the present invention, this information may be stored, e.g., on a central server. Upon downloading a client application on the user's mobile device, the user may be able to access and listen to each of the items of musical content (e.g., song, melody, or other music) on the user's computer via the user's mobile device. That is, in accordance with one aspect, the method and system of the present invention stream the item of musical content from the content provider's library (e.g., Sony, Warner, and independent labels, among others) directly to the user's mobile device. In accordance with one aspect, the application downloaded on the user's computer may update the data stored on the central server each time the user makes changes to the musical content on the user's computer (e.g., when the user downloads music from a Compact Disk (CD) or via the web).

In accordance with aspects of the present invention, the user may also listen to web radio on the user's mobile device in accordance with the preferences specified in the user's profile, if available, and/or in accordance with the extrapolated data from the musical content on the user's computer (e.g., regarding genres, artists and musical content), if such web radio is available based on the location coordinates of the user, as determined, e.g., by the GPS function or other location functions on the user's mobile device.

In accordance with an aspect of the present invention, a user may be able to interactively indicate, from the user's mobile device, the specific item of musical content that the user desires to listen to on the user's mobile device. The method and system of the present invention may stream that specific item of musical content to the user's mobile device. It should be noted that such interactive streaming/distribution will be performed based on existence of the relevant licenses with content providers. In accordance with one aspect, the user may have the option of making a single payment for a specific item of musical content, and having the item streamed as many times as desired to the user's mobile telephone (i.e., a pay-once stream-anytime option).

In accordance with one aspect, the user may be able to access information regarding the musical content that is being streamed on the user's mobile device, such as the name of the song, the performer, the bio and/or other details of the performer, the lyrics of the song, a list of events of the performer and/or a list of events of other performers that perform similar music. Further, the user may be able to rate and/or tag the musical content that is being streamed. In addition, the user may have access to functions such as play, stop, replay, rewind and fast forward, among others, with respect to the musical content being streamed. The user may be able to access this information and functions on the user's mobile device, displayed on the screen, via audio, or both, contemporaneously with the musical content being played and/or at a later time.

In accordance with aspects of the present invention, a content provider may provide information to a user, via the user's mobile device, on a number of activities, such as concerts and events, among others, based on the user's profile preferences, whether automatically updated or updated by the user. In accordance with one aspect, third parties may also provide information to the user, based on the user's preferences, on events, concerts and/or other activities. In accordance with one aspect, the user may be able to execute a transaction (e.g., purchase tickets to a concert, purchase music), with such content providers and/or third parties.

For example, a user may be able to select an “events” option, and may be provided with a list of activities and/or options for purchasing music, based on the user's preferences and/or vicinity. The user may select an item from the list and may execute a transaction. In addition, in accordance with aspects of the present invention, software developers may provide to the user, via the user's mobile device, various applications, such as web-based widgets, flash player tools, and software developers' tools, among others.

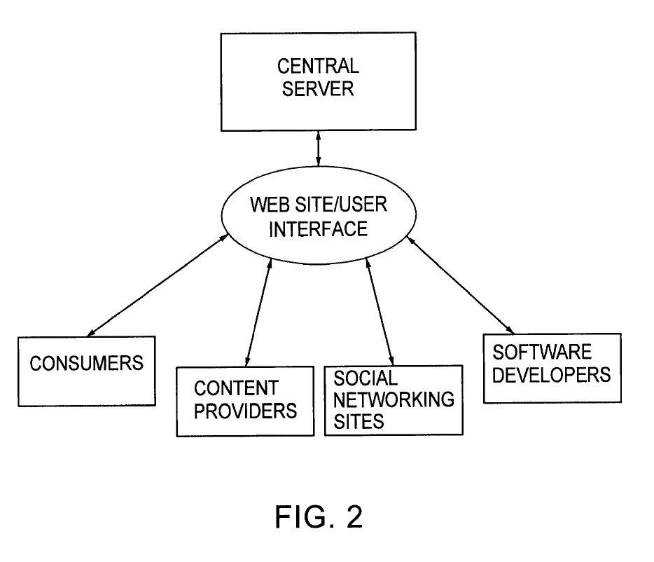

Referring now to FIG. 2, therein shown is an open architecture technology platform, in accordance with aspects of the present invention. The central server stores the user profile, preferences and other information. Via the web site and the user interface, the central server is connected with consumers, musical content providers, social networking sites, software developers, and other entities. In addition, each of the consumers, content providers, social networking sites and software developers may communicate among each other via the central server.

Aspects of the present invention are directed to enhancing user satisfaction with sharing and discovering digital files, which may be achieved by ensuring that the parameters for describing a digital file as being a strong candidate for sharing, discovery, or consumption, reflect the impact of locations and personae on ultimate user satisfaction.

According to aspects of the present invention, presentation of a digital file may occur in real-time as that file is identified with a person or place, after having been identified with a person or place, or in anticipation of how closely that file fits the preferences of a person based on traditional recommendation analytics, or in anticipation of how closely that file fits a collection of one or more files associated with a given location.

For example, a user may be identified uniquely to a, e.g., computer system with one or more identifiers. A location may also be identified uniquely to a system with one or more identifiers. The system may contain one or more identifiable digital files, including but not limited to video, still images, and music. Each of these files may be associated with zero, one, or more persons or locations.

According to aspects of the present invention, when a user desires to share one or more files with another user (known or unknown) over a network (e.g., wired or wireless), the formatting of that associated content to the recipient or recipients may include media such as text, still images, animations, graphics, video, music, or other media not here identified, sufficient to identify the person (and/or his persona) to the recipient. The sharing need not be consumed by the recipient to be protected. The person whose identity (or identities) is associated with the files need not be well-known to the recipient.

Similarly, in accordance with aspects of the present invention, when a location becomes associated with one or more identifiable digital files, including but not limited to video, still images, and music, the formatting of that associated content may include media such as text, still images, animations, graphics, video, music, or other media sufficient to identify the location to the recipient. The sharing need not be consumed by the recipient to be protected. The location associated with the files need not be well-known to the recipient.

Aspects of the present invention will be more readily apparent upon consideration of the following example scenarios.

### Scenario 1

A user at a computer creates a user account under a pseudonym. Using, e.g., a World Wide Web-based map, the user associates favorite songs performed by a specific band with locations where the band has performed in the past. For many of these locations, the user also uploads digital pictures from the user's own collection, as well as references to digital pictures from elsewhere on, e.g., the Internet. These songs and images are now associated both with the user and the locations.

Users of the Internet with access to these media can recognize the places associated with these media, or the persona who assembled these media, or both.

### Scenario 2

A user with a mobile phone featuring a properly designed application is alerted of being near a location associated with music the user is likely to enjoy. Responding to the alert via the mobile phone, the user consumes the music, as well as any other digital files, associated with that location.

### Scenario 3

A user is exploring a trip to Rome, Italy. Using a properly designed Web application, the user can see pictures and hear music associated with Rome, Italy, which have been associated by one or more personae.

### Scenario 4

A user with a mobile phone featuring a properly designed application is alerted that a friend is now listening to music. The user decides to listen to the same music.

### Scenario 5

Combining a traditional recommendation engine with aspects of the present invention, a system associates digital files with User A that user B is likely to enjoy, based upon an analysis of User B's tastes and preferences. User A may be a real person, or a persona representing a computer algorithm. User B accesses these files via a mobile phone.

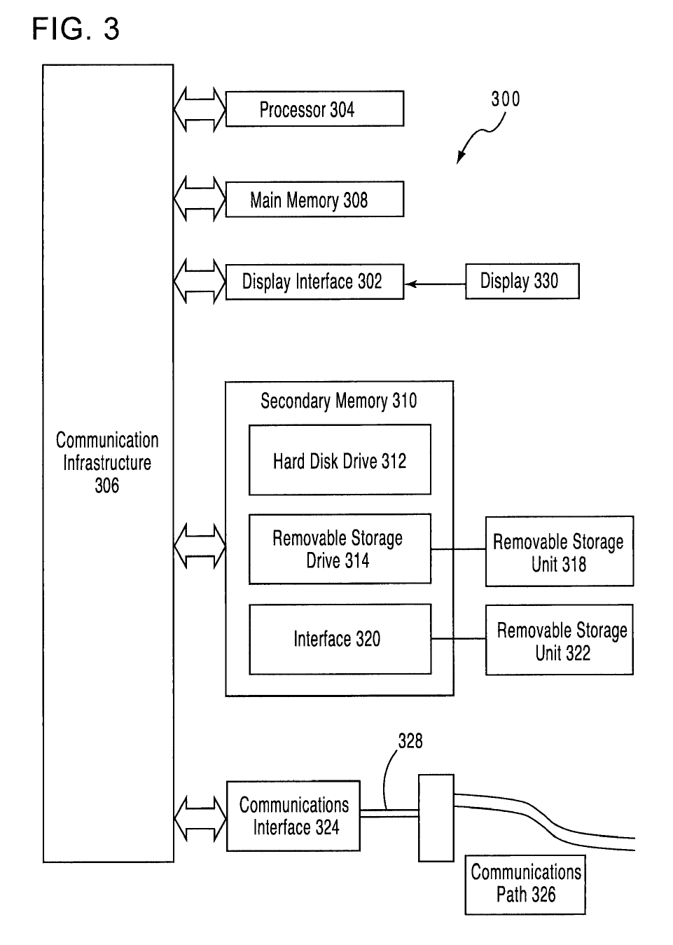

The present invention may be implemented using hardware, software, or a combination thereof and may be implemented in one or more computer systems or other processing systems. In accordance with one variation, a software aspect of the present invention may be implemented in Java 1.5, among other options. In one aspect, the invention is directed toward one or more computer systems capable of carrying out the functionality described herein. An example of such a computer system 300 is shown in FIG. 3.

Computer system 300 includes one or more processors, such as processor 304. The processor 304 is connected to a communication infrastructure 306 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 300 can include a display interface 302 that forwards graphics, text, and other data from the communication infrastructure 306 (or from a frame buffer not shown) for display on a display unit 330. Computer system 300 also includes a main memory 308, preferably random access memory (RAM), and may also include a secondary memory 310. The secondary memory 310 may include, for example, a hard disk drive 312 and/or a removable storage drive 314, representing a floppy disk drive, a magnetic tape drive, an optical disk drive, etc. The removable storage drive 314 reads from and/or writes to a removable storage unit 318 in a well-known manner. Removable storage unit 318, represents a floppy disk, magnetic tape, optical disk, etc., which is read by and written to removable storage drive 314. As will be appreciated, the removable storage unit 318 includes a computer usable storage medium having stored therein computer software and/or data.

In alternative aspects, secondary memory 310 may include other similar devices for allowing computer programs or other instructions to be loaded into computer system 300. Such devices may include, for example, a removable storage unit 322 and an interface 320. Examples of such may include a program cartridge and cartridge interface (such as that found in video game devices), a removable memory chip (such as an erasable programmable read only memory (EPROM), or programmable read only memory (PROM)) and associated socket, and other removable storage units 322 and interfaces 320, which allow software and data to be transferred from the removable storage unit 322 to computer system 300.

Computer system 300 may also include a communications interface 324. Communications interface 324 allows software and data to be transferred between computer system 300 and external devices. Examples of communications interface 324 may include a modem, a network interface (such as an Ethernet card), a communications port, a Personal Computer Memory Card International Association (PCMCIA) slot and card, etc. Software and data transferred via communications interface 324 are in the form of signals 328, which may be electronic, electromagnetic, optical or other signals capable of being received by communications interface 324. These signals 328 are provided to communications interface 324 via a communications path (e.g., channel) 326. This path 326 carries signals 328 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 314, a hard disk installed in hard disk drive 312, and signals 328. These computer program products provide software to the computer system 300. The invention is directed to such computer program products.

Computer programs (also referred to as computer control logic) are stored in main memory 308 and/or secondary memory 310. Computer programs may also be received via communications interface 324. Such computer programs, when executed, enable the computer system 300 to perform the features of the present invention, as discussed herein. In particular, the computer programs, when executed, enable the processor 310 to perform the features of the present invention. Accordingly, such computer programs represent controllers of the computer system 300.

In an aspect where the invention is implemented using software, the software may be stored in a computer program product and loaded into computer system 300 using removable storage drive 314, hard drive 312, or communications interface 320. The control logic (software), when executed by the processor 304, causes the processor 304 to perform the functions of the invention as described herein. In another aspect, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another aspect, the invention is implemented using a combination of both hardware and software.

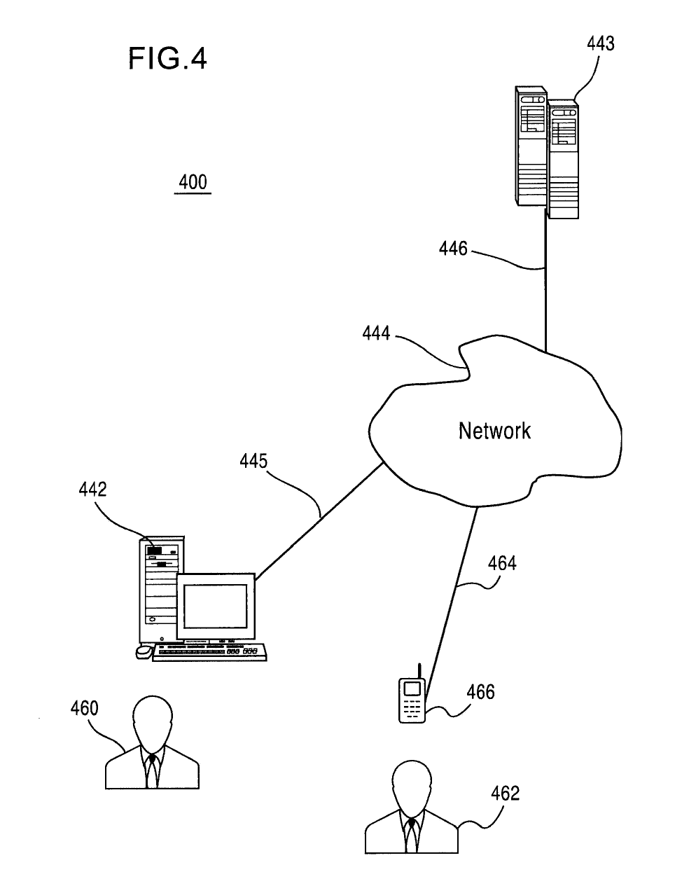

FIG. 4 shows a communication system 400 usable in accordance with aspects of the present invention. The communication system 400 includes one or more accessors 460, 462 (also referred to interchangeably herein as one or more “users”), one or more terminals 442, and one or more mobile devices 466. In one aspect, data for use in accordance with the present invention is, for example, input and/or accessed by accessors 460, 464 via terminals 442, 466, such as personal computers (PCs), minicomputers, mainframe computers, microcomputers, telephonic devices, or wireless devices, such as PDAs and Blackberry devices, or hand-held wireless devices coupled to a server 443, such as a PC, minicomputer, mainframe computer, microcomputer, or other device having a processor and a repository for data and/or connection to a repository for data, via, for example, a network 444, such as the Internet or an intranet, and couplings 445, 446, 464. The couplings 445, 446, 464 include, for example, wired, wireless, or fiberoptic links. In another aspect, the method and system of the present invention operate in a stand-alone environment, such as on a single terminal.

While the present invention has been described in connection with preferred embodiments, it will be understood by those skilled in the art that variations and modifications of the preferred embodiments described above may be made without departing from the scope of the invention. Other embodiments will be apparent to those skilled in the art from a consideration of the specification or from a practice of the invention disclosed herein.

1. A method of distributing musical content, the method comprising:
receiving a first user profile;
downloading a client application to a mobile device of the first user;
distributing, via the client application, musical content to the first user based on one of the first user profile, a second user identifier and a place identifier; and
updating the first user profile.

2. The method of claim 1, further comprising:
providing information to the first user, via the client application, based on the distributed musical content.

3. The method of claim 1, wherein the first user profile includes musical preferences of the first user.

4. The method of claim 1, wherein the first user profile is updated based on the distributed musical content.

5. The method of claim 1, wherein the second user identifier uniquely identifies the second user.

6. The method of claim 1, wherein the place identifier uniquely identifies the place.

7. A system for distributing musical content, the system comprising:
a module for receiving a first user profile;
a module for downloading a client application to a mobile device of the first user;
a module for distributing, via the client application, musical content to the first user based on one of the first user profile, a second user identifier and a place identifier; and
a module for updating the first user profile.

8. The system of claim 7, further comprising:
a module for providing information to the first user, via the client application, based on the distributed musical content.

9. The system of claim 7, wherein the first user profile includes musical preferences of the first user.

10. The system of claim 7, wherein the first user profile is updated based on the distributed musical content.

11. The system of claim 7, wherein the second user identifier uniquely identifies the second user.

12. The system of claim 7, wherein the place identifier uniquely identifies the place.

13. A system for distributing musical content, the system comprising:
a processor;
a user interface functioning via the processor; and
a repository accessible by the processor;
wherein a first user profile is received;
wherein a client application is downloaded to a mobile device of the first user;
wherein musical content is distributed to the first user, via the client application, based on one of the first user profile, a second user identifier and a place identifier; and
wherein the first user profile is updated.

14. The system of claim 13, wherein the processor is housed on a server.

15. The system of claim 14, wherein the server is selected from a group consisting of a personal computer, a minicomputer, a microcomputer, and a main frame computer.

16. The system of claim 15, wherein the server is coupled to a network.

17. The system of claim 16, wherein the network is the Internet.

18. The system of claim 13, wherein the repository is housed on a server.

19. The system of claim 18, wherein the server is coupled to a network.

20. A computer program product comprising a computer usable medium having control logic stored therein for causing a computer to distribute musical content, the control logic comprising:
computer readable program code means for receiving a first user profile;
computer readable program code means for downloading a client application to a mobile device of the first user;
computer readable program code means for distributing, via the client application, musical content to the first user based on one of the first user profile, a second user identifier and a place identifier; and
computer readable program code means for updating the first user profile.
